(19) United States
(12) Patent Application Publication
(10) Pub. No.: US 2026/0045176 A1
(43) Pub. Date: Feb. 12, 2026

(54) METHOD OF FUGITIVE APPREHENSION

(71) Applicant: OCTOLYTIX, LLC, Annapolis, MD (US)

(72) Inventors: Sandy Rao, Annapolis, MD (US); Tom McDaniel, Annapolis, MD (US); Hank Martin, Annapolis, MD (US)

(21) Appl. No.: 19/294,590

(22) Filed: Aug. 8, 2025

Related U.S. Application Data
(60) Provisional application No. 63/681,326, filed on Aug. 9, 2024.

(51) Int. Cl. G09B 19/00; G06V 10/70; G06V 20/52; G06V 40/10; G06V 40/20; G09B 5/06

(52) U.S. Cl. CPC G09B 19/00; G06V 10/70; G06V 20/52; G06V 40/10; G06V 40/20; G09B 5/06

(57) ABSTRACT

The disclosure herein relates to a method for training law enforcement personnel to anticipate a subject's action, the method including receiving information relating to the subject; identifying, based on the received information, a pattern in at least one of the subject's behavior, movement, and interaction with a human; and training law enforcement personnel using a specialized training module, the specialized training module including case studies comprising previous tactics used by the subjects to avoid capture by law enforcement personnel, successful capture techniques of subjects, pattern of life analysis of the subject, and surveillance of the subject.

### TECHNICAL FIELD The invention relates to the field of law enforcement and fugitive apprehension.

### BACKGROUND

Fugitive apprehension is a critical aspect of law enforcement, involving the location and capture of individuals who have evaded arrest or escaped from custody. Fugitives may be wanted for a variety of crimes, ranging from minor offenses to serious felonies, and their successful apprehension is essential for maintaining public safety and upholding the rule of law.

However, locating and apprehending fugitives requires specialized training and expertise. The practice of tracking and capturing fugitives has evolved over centuries. In early history, communities relied on local militias and informal networks to apprehend individuals who fled justice. With the development of organized police forces in the 19th and 20th centuries, more systematic approaches to fugitive apprehension emerged. Law enforcement agencies began to adopt standardized procedures, specialized units, and technological advancements to improve their ability to locate and capture fugitives.

Today's fugitives often employ sophisticated methods to avoid capture, including the use of false identities, frequent movement, and exploitation of legal loopholes. Additionally, advancements in technology have both aided and complicated the task of fugitive apprehension. While law enforcement agencies now have access to powerful tools such as surveillance cameras, databases, and forensic techniques, fugitives may use encrypted communications, digital currencies, and other technologies to evade detection.

Accordingly there is a need for innovative methods of fugitive apprehension.

### SUMMARY

The present invention provides a training program designed to equip law enforcement personnel with the necessary skills and techniques to locate and apprehend fugitives. The program includes foundational and advanced courses, specialized training modules, and customized training programs tailored to meet the specific needs of individual agencies.

### BRIEF DESCRIPTION OF DRAWINGS

FIG. 1 is a block diagram of the MAFIP curriculum structure, according to one example.

FIG. 2 is a block diagram of the Basic Fugitive Investigation Training (BFIT) course components, according to one example.

FIG. 3 is a block diagram of the Advanced Fugitive Investigation Training (AFIT) course components, according to one example.

FIG. 4 is a schematic of a controller, according to one example.

### DETAILED DESCRIPTION

The descriptions, illustrations, and examples in the present disclosure are given by illustration only and are by no means a limitation. The descriptions, illustrations, and examples are described and discussed in such a way that one skilled in the art may understand and appreciate the principles and practices of the disclosure. Various modifications such as substitutions, additions, rearrangements, may be made that remain potential applications of the disclosed processes.

The disclosure herein relates to a training program for law enforcement personnel (hereafter referred to as “officers”), specifically designed to equip them with skills and techniques for locating and apprehending fugitives using pattern of life analysis and other investigative processes described herein.

Effective fugitive apprehension requires a combination of investigative techniques, interagency cooperation, and specialized training. Key strategies include: (i) pattern of life analysis, (ii) surveillance, (iii) confidential informants, (iv) interagency collaboration, and (v) technological tools.

For example, (for pattern of life analysis) investigators analyze the daily routines, behaviors, and social connections of fugitives to predict their movements and identify potential hiding places. This method leverages data from various sources, including financial transactions, social media activity, and communications records.

For example, (for surveillance) both stationary (static) and mobile surveillance techniques are used to monitor the activities of fugitives and their associates. This can involve physical observation, electronic tracking, and the use of surveillance technology such as cameras and drones.

For example, (for confidential informants) law enforcement agencies often rely on informants to provide inside information about a fugitive's whereabouts and activities. The development and management of these sources require careful handling to ensure reliability and safety.

For example, (for interagency collaboration) fugitive apprehension frequently involves coordination between multiple law enforcement agencies, including local, state, federal, and international bodies. Sharing intelligence and resources enhances the effectiveness of operations and helps overcome jurisdictional challenges.

For example, (for technological tools) fugitive investigations make extensive use of technology, including data analytics, facial recognition software, and electronic surveillance devices. These tools help investigators to process large volumes of information, identify patterns, and track fugitives more efficiently.

To address the complexities of fugitive apprehension, law enforcement officers require specialized training. Programs such as the Manhunting & Fugitive Investigations Program (MAFIP) provide comprehensive education in the skills and techniques needed for successful fugitive investigations. Training covers areas such as pattern of life analysis, surveillance methods, non-custodial interviewing, financial investigation, and the use of technology in law enforcement.

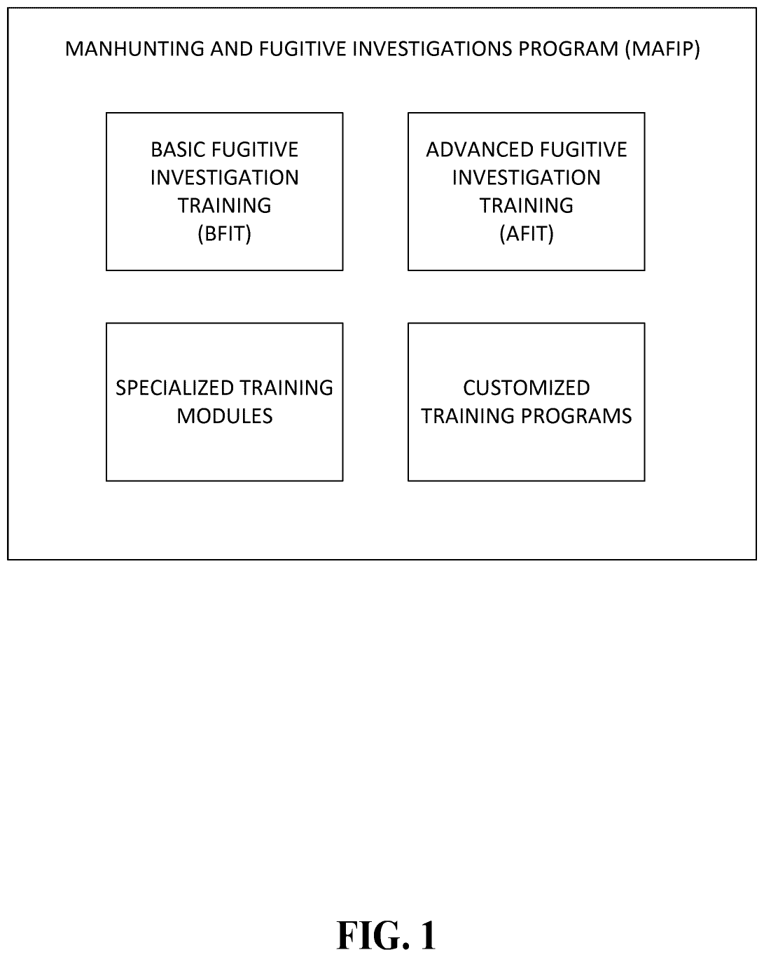

FIG. 1 is a block diagram of the MAFIP curriculum structure. The MAFIP is designed to provide law enforcement officers with a set of skills and techniques for locating and apprehending fugitives. The program is structured into four components: (i) Basic Fugitive Investigation Training (BFIT), (ii) Advanced Fugitive Investigation Training (AFIT), (iii) Specialized Training Modules, and (iv) Customized Training Programs.

### BASIC FUGITIVE INVESTIGATION TRAINING

The Basic Fugitive Investigation Training (BFIT) is a course that covers the fundamentals of fugitive investigations. This course includes techniques for analyzing the daily activities and behaviors of fugitives to predict their movements and locations. Officers learn methods for conducting both stationary and mobile surveillance to monitor fugitive activities. The course also covers skills for conducting interviews, gathering intelligence, and processing evidence. Officers are trained to use databases and other resources for background checks and intelligence gathering. Collaboration with other law enforcement agencies is emphasized to leverage shared resources.

### ADVANCED FUGITIVE INVESTIGATION TRAINING

The Advanced Fugitive Investigation Training (AFIT) is a course designed for officers who have completed the BFIT. This course focuses on specialized topics. Officers learn techniques for interviewing individuals without taking them into custody. The course covers methods for tracking financial transactions to locate fugitives. Officers are trained in the use of electronic devices and technologies to monitor fugitive activities. The course also includes strategies for identifying and managing confidential informants. Officers learn to assess the reliability of sources and extract actionable intelligence.

### SPECIALIZED TRAINING MODULES

The specialized training modules offer officers the opportunity to focus on specific areas of interest or need within fugitive investigations. These modules include techniques for analyzing behavioral patterns to predict fugitive actions. Officers learn methods for tracking and apprehending fugitives. The modules cover the use of modern technologies to support fugitive investigations. Officers are trained in data analytics, facial recognition software, and social media monitoring tools.

In one example, the specialized training modules include a module on behavioral pattern analysis. The module on behavioral pattern analysis covers techniques for understanding and predicting the actions of fugitives based on their behavior. Officers are trained in methods for collecting and interpreting data related to a fugitive's habits, routines, and interactions. This training includes the analysis of social media activity, communication records, and other sources of behavioral data. By identifying patterns in this data, officers can anticipate future movements and actions, aiding in the strategic planning of surveillance and apprehension operations.

In one example, the specialized training modules include a module on tracking and apprehension methods. The module on tracking and apprehension methods provides instruction on various techniques for locating and capturing fugitives. Officers learn procedures for conducting static and mobile surveillance, using undercover operations, and coordinating multi-agency efforts. The training includes practical exercises in the use of tracking devices, covert observation, and rapid response tactics. Officers are also trained in the legal and procedural aspects of fugitive apprehension, ensuring compliance with laws and regulations during operations.

In one example, the specialized training modules include a module on modern technologies in fugitive investigations. The module on modern technologies in fugitive investigations introduces officers to advanced tools and techniques that support their efforts. Training covers the use of data analytics to process and analyze large volumes of information, identifying relevant patterns and connections. Officers learn to use facial recognition software to match images of fugitives against databases and surveillance footage. The module also includes instruction on social media monitoring tools, which allow officers to track the online activities and interactions of fugitives in real-time.

In one example, the specialized training modules include a module on data analytics training. Data analytics training within the modules involves the use of specialized software to analyze complex datasets. Officers are instructed on methods for organizing, filtering, and interpreting data from various sources, such as financial transactions, communication logs, and public records. This analysis helps to identify significant trends and anomalies that may indicate the fugitive's location or plans. Officers learn to generate reports and visualizations that summarize their findings and support decision-making processes.

In one example, the specialized training modules include a module on facial recognition software training. The facial recognition software training module provides officers with the skills to use this technology effectively in fugitive investigations. Officers learn to input images into the software, adjust parameters to improve accuracy, and interpret the results. The training includes best practices for integrating facial recognition data with other investigative information to enhance overall situational awareness. Officers are also briefed on the legal considerations and privacy issues related to the use of facial recognition technology.

In one example, the specialized training modules include a module on social media monitoring tools. Social media monitoring tools training covers the techniques for tracking and analyzing the online presence of fugitives. Officers learn to use software platforms that aggregate social media activity, identify connections, and monitor posts in real-time. The training emphasizes the importance of cross-referencing social media data with other sources of information to verify accuracy and relevance. Officers are instructed on how to document findings from social media monitoring and incorporate this data into their overall investigative strategy.

By completing these specialized training modules, officers gain targeted expertise in specific areas of fugitive investigations, enhancing their ability to conduct effective and efficient operations. The integration of behavioral pattern analysis, advanced tracking methods, modern technologies, data analytics, facial recognition, and social media monitoring equips officers with a comprehensive toolkit for addressing the complex challenges of fugitive apprehension.

### CUSTOMIZED TRAINING PROGRAMS

The customized training programs are tailored to meet the specific needs of individual agencies. These programs cover topics such as techniques for locating and apprehending fugitives across international borders. Officers learn methods for tracking and apprehending military personnel who are fugitives. The programs also cover strategies for investigating and resolving cases involving missing children. Officers are trained in the use of AMBER Alert systems and collaboration with child advocacy organizations.

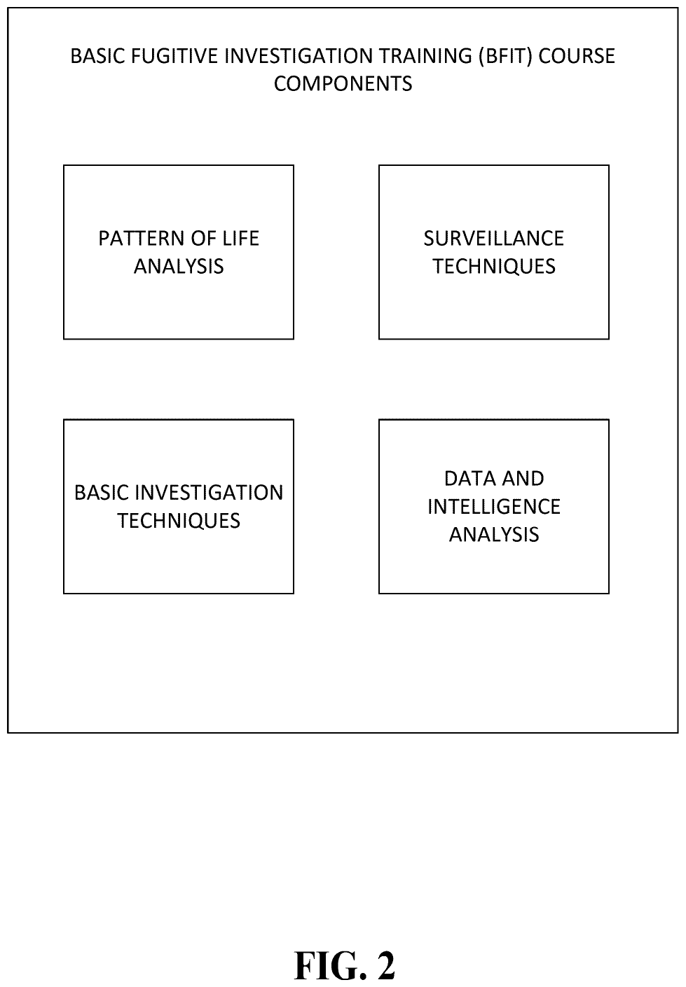

FIG. 2 is a block diagram of the Basic Fugitive Investigation Training (BFIT) course components. The BFIT course includes: (i) pattern of life analysis; (ii) surveillance techniques; (iii) basic investigation techniques; and (iv) data and intelligence analysis.

pattern of life analysis is a critical component of fugitive investigations, providing law enforcement officers with the ability to predict the movements and behaviors of fugitives based on their daily activities and routines. This method involves collecting and analyzing various forms of data to create a comprehensive profile of the fugitive's habits, interactions, and locations frequented. By understanding these patterns, officers can anticipate the fugitive's future actions and make informed decisions on where and when to conduct surveillance or apprehension operations.

data collection for pattern of life analysis involves gathering information from multiple sources. Social media platforms are a valuable resource, as fugitives often leave digital footprints through posts, check-ins, and interactions with others. Financial transactions, such as credit card purchases and bank withdrawals, provide insight into the fugitive's spending habits and locations they visit. Communication records, including phone calls, text messages, and emails, reveal the fugitive's contacts and potential accomplices. Public records, such as property ownership, vehicle registrations, and utility bills, can also contribute to understanding the fugitive's lifestyle and movements.

Once data is collected, officers use various analytical techniques to identify patterns and correlations within the information. Temporal analysis examines the timing of activities to determine routines and predict future movements. Spatial analysis focuses on the geographic locations frequented by the fugitive, identifying areas of interest and potential hideouts. Social network analysis maps the fugitive's connections and interactions with others, highlighting relationships that may assist in locating the fugitive. By integrating these analyses, officers can build a detailed profile of the fugitive's behavior.

Integration of data from multiple sources is essential to create a comprehensive pattern of life profile. Combining information from social media, financial transactions, and communication records allows officers to cross-reference and validate findings. For example, a social media post indicating a location can be corroborated with a financial transaction at a nearby establishment. This multi-source approach ensures that the analysis is robust and accurate, reducing the likelihood of relying on incomplete or misleading data.

The final step in pattern of life analysis is the application of findings to operational planning. Officers use the detailed profiles created from the analysis to inform their decisions on where and when to deploy resources. For example, if a fugitive is found to regularly visit a particular location at specific times, officers can plan surveillance or apprehension operations accordingly. This strategic use of information enhances the efficiency and effectiveness of fugitive investigations, increasing the likelihood of successful apprehension while minimizing risks and resource expenditure.

Surveillance Techniques in fugitive investigations involve a range of methods for monitoring the activities of fugitives and their associates. The primary goal of surveillance is to gather information without the subject becoming aware, thereby preserving the integrity of the investigation. Surveillance can be conducted through both static and mobile methods, each with specific applications and procedures to ensure effective observation.

Static surveillance involves maintaining a fixed position to observe a specific location or target. This method is particularly useful for monitoring known addresses, workplaces, or frequent meeting spots of the fugitive. Officers involved in static surveillance must remain inconspicuous and often use covert observation points, such as parked vehicles, nearby buildings, or natural cover. The success of static surveillance depends on careful planning, including selecting appropriate vantage points and understanding the target's routines to avoid detection.

Mobile surveillance is the practice of following a fugitive or their associates while they move from one location to another. This method requires coordination and communication among multiple officers or teams to maintain continuous observation. Mobile surveillance can involve various modes of transportation, including vehicles, bicycles, or on foot, depending on the fugitive's movements and the environment. Officers conducting mobile surveillance must be skilled in maintaining a discreet distance and adapting to sudden changes in the fugitive's behavior or route.

Surveillance technology enhances the capabilities of both static and mobile surveillance operations. The use of cameras, tracking devices, and other monitoring tools allows officers to capture visual and audio evidence without being physically present. Cameras can be installed in strategic locations to record activities at known addresses or meeting spots, while GPS tracking devices can be attached to vehicles or personal items to monitor the fugitive's movements. Drones and other aerial surveillance tools provide an additional layer of observation, particularly in large or inaccessible areas.

Effective communication is crucial for successful surveillance operations. Officers must use secure communication channels to relay real-time information and coordinate their actions. This ensures that surveillance teams can respond quickly to changes in the fugitive's movements and maintain continuous observation. Standard operating procedures and protocols guide the communication process, minimizing the risk of errors or misunderstandings that could compromise the investigation.

Operational security is a fundamental aspect of surveillance techniques. Officers must take measures to avoid detection by the fugitive or third parties, which could alert the fugitive to the investigation and cause them to alter their behavior or flee. This includes using unmarked vehicles, disguises, and varying observation points and routes to prevent patterns that could be recognized. Maintaining operational security also involves managing the information gathered during surveillance, ensuring it is stored and shared securely to protect the integrity of the investigation and the privacy of individuals involved.

Basic investigation techniques are foundational skills that law enforcement officers use to gather and analyze information in fugitive investigations. These techniques provide the necessary tools to build a comprehensive understanding of a fugitive's activities, associations, and whereabouts. The primary methods include interviewing witnesses and informants, collecting and preserving evidence, conducting intelligence gathering, and collaborating with other law enforcement agencies.

Interviewing witnesses and informants is a crucial aspect of basic investigation techniques. Officers must develop the ability to elicit useful information through structured and strategic questioning. This involves establishing rapport, understanding the context of the witness or informant's knowledge, and distinguishing between factual information and personal perceptions. Effective interviewing also requires documenting responses accurately and cross-referencing with other data to verify the reliability of the information provided.

Evidence collection and preservation are vital components of any investigation. Officers must be proficient in identifying potential evidence at a crime scene or during surveillance operations. This includes physical evidence, such as fingerprints, DNA, and personal belongings, as well as digital evidence, like emails, texts, and social media activity. Proper procedures for collecting, labeling, and storing evidence ensure that it remains uncontaminated and admissible in court. Additionally, officers must document the chain of custody for each piece of evidence to maintain its integrity throughout the investigation process.

Intelligence gathering involves the systematic collection of data from various sources to build a comprehensive profile of the fugitive. This can include public records, financial transactions, communication logs, and social media activity. Officers must know how to access and analyze these records to uncover patterns and connections that may indicate the fugitive's location or future actions. Effective intelligence gathering also involves staying current with available databases and analytical tools that can enhance the ability to process large volumes of information efficiently.

Collaboration with other law enforcement agencies is essential in fugitive investigations. Given the mobility of fugitives, they often cross jurisdictional boundaries, requiring coordinated efforts among local, state, federal, and sometimes international agencies. Effective collaboration involves sharing intelligence, resources, and expertise to enhance the overall effectiveness of the investigation. Establishing clear communication channels and protocols ensures that all involved agencies can contribute to and benefit from the collective effort to apprehend the fugitive.

Finally, the documentation and reporting of investigative activities are critical for ensuring accountability and transparency. Officers must maintain detailed records of all actions taken during the investigation, including interviews conducted, evidence collected, and intelligence gathered. These records provide a chronological account of the investigation and are essential for preparing reports, supporting operational decisions, and presenting findings in court. Proper documentation also facilitates the review and evaluation of the investigation, identifying areas for improvement and ensuring compliance with legal and procedural standards.

Data and intelligence analysis are fundamental components in fugitive investigations, enabling law enforcement officers to process and interpret information collected from various sources. This analytical process helps in developing a detailed understanding of a fugitive's behaviors, movements, and associations, ultimately guiding strategic decision-making and operational planning.

The process begins with the collection of data from diverse sources. This includes public records, financial transactions, communication logs, social media activities, and surveillance footage. Each source provides unique insights into the fugitive's life, contributing to a comprehensive dataset. Officers must be adept at accessing these sources and extracting relevant information, ensuring that they gather a broad spectrum of data to support their analysis.

Once data is collected, officers employ various analytical techniques to make sense of the information. Temporal analysis involves examining the timing of events and activities to identify patterns and routines. For instance, regular financial transactions or communication activities can reveal the fugitive's habits and predict future behavior. Spatial analysis focuses on geographic data, mapping the locations frequented by the fugitive to identify potential hideouts or areas of interest. Social network analysis maps the relationships and interactions between the fugitive and their contacts, uncovering potential accomplices or sources of support.

The integration of data from multiple sources is crucial for building a comprehensive intelligence picture. Cross-referencing information allows officers to validate findings and identify correlations that might not be apparent when viewing data in isolation. For example, a financial transaction at a specific location can be cross-referenced with social media check-ins or surveillance footage to confirm the fugitive's presence. This multi-source approach enhances the accuracy and reliability of the analysis, providing a more robust foundation for decision-making.

The application of analytical tools and software is an essential aspect of data and intelligence analysis. Various technologies are available to assist officers in processing large volumes of data efficiently. Data analytics software can automate the identification of patterns and anomalies, while geographic information systems (GIS) can visualize spatial data on maps. Additionally, social media monitoring tools can track online activities and interactions in real-time. These tools augment the analytical capabilities of officers, allowing them to handle complex datasets and derive actionable insights quickly.

The findings from data and intelligence analysis are used to inform operational planning and decision-making. Detailed intelligence reports are prepared, summarizing the key insights and recommendations. These reports guide the allocation of resources, the planning of surveillance or apprehension operations, and the coordination with other law enforcement agencies. By leveraging the insights gained from data and intelligence analysis, officers can enhance the effectiveness of their investigations, improving the likelihood of successfully locating and apprehending fugitives.

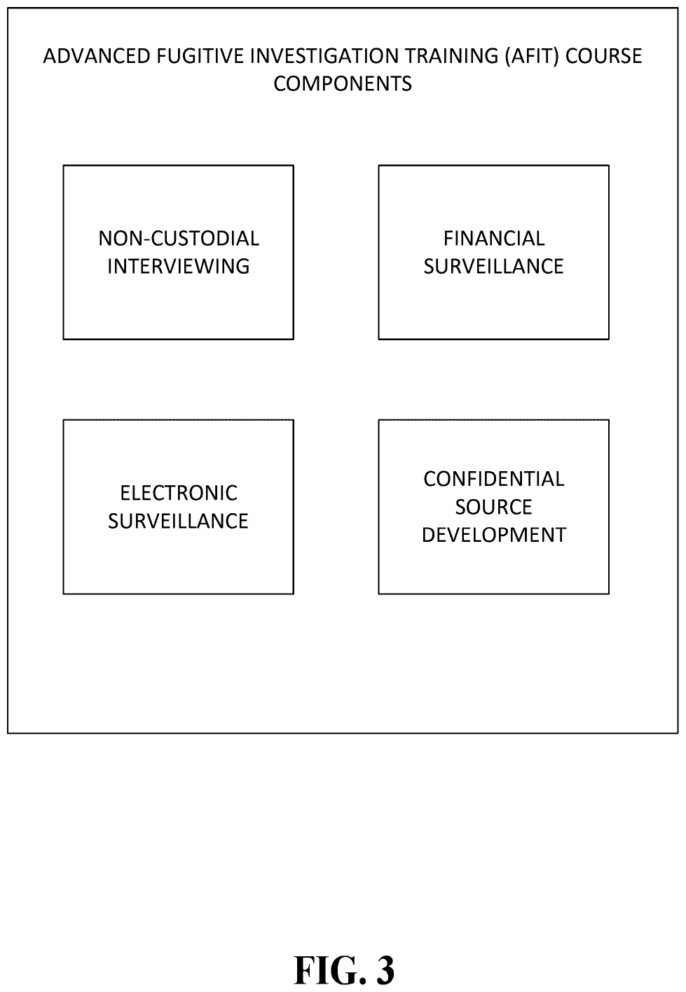

FIG. 3 is a schematic of the Advanced Fugitive Investigation Training (AFIT) course components. The AFIT course is structured to provide experienced law enforcement officers with advanced skills and techniques necessary for complex fugitive investigations. The course builds on foundational knowledge from the BFIT and focuses on specialized topics. The AFIT course is divided into several key components including: (i) non-custodial interviewing; (ii) financial surveillance, (iii) electronic surveillance, and (iv) confidential source development.

Non-custodial interviewing is a technique for gathering information from individuals without taking them into custody. This component of the AFIT course teaches officers methods for conducting effective interviews in non-custodial settings. Officers learn strategies for building rapport with interview subjects, phrasing questions to elicit detailed responses, and interpreting verbal and non-verbal cues. The training covers legal considerations and best practices to ensure that information obtained during non-custodial interviews is admissible and reliable.

Financial surveillance involves tracking the financial activities of fugitives to uncover their whereabouts and support networks. In this component, officers are trained in the use of financial records, banking transactions, and other monetary data to trace fugitive movements. Techniques for identifying patterns in financial behavior, linking transactions to specific locations, and detecting money laundering activities are covered. Officers learn to collaborate with financial institutions and use specialized software tools to analyze financial data effectively.

Electronic surveillance encompasses the use of technology to monitor fugitive communications and activities. This component provides officers with knowledge and skills for deploying and managing electronic surveillance tools, such as wiretaps, GPS tracking devices, and video surveillance systems. Officers learn procedures for obtaining and executing surveillance warrants, setting up and maintaining surveillance equipment, and interpreting data collected through electronic means. Training includes compliance with legal standards and protocols to ensure the integrity of electronic surveillance operations.

Confidential source development focuses on the recruitment and management of informants who provide critical information about fugitives. In this component, officers are instructed on methods for identifying potential informants, assessing their reliability, and establishing secure communication channels. Techniques for motivating and protecting informants, as well as strategies for handling informant-provided information, are emphasized. Officers learn to document interactions with informants meticulously and maintain confidentiality to safeguard the informants and the investigation.

The AFIT course also includes training on integrating the various advanced techniques into a cohesive investigative strategy. Officers learn to synthesize information obtained from non-custodial interviews, financial surveillance, electronic surveillance, and confidential sources to develop comprehensive profiles of fugitives. This integration enables officers to plan and execute operations with greater precision, enhancing their ability to locate and apprehend fugitives efficiently. The course emphasizes continuous evaluation and adaptation of investigative strategies based on real-time data and intelligence.

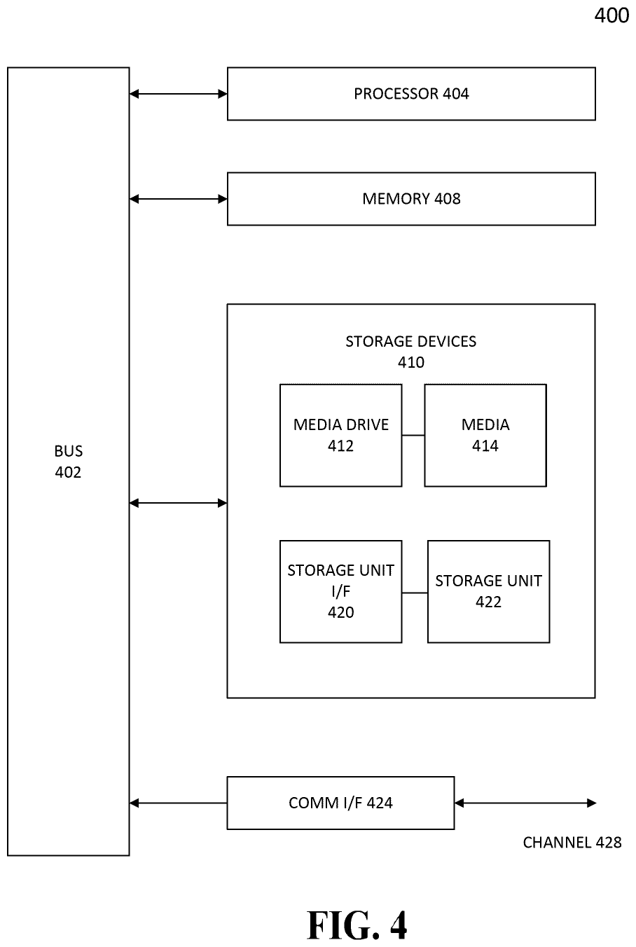

FIG. 4 is a schematic of a controller, according to one example. The controller 400 includes a processor 404. The processor 404 can be implemented using a general-purpose or special-purpose processing engine such as, for example, a microprocessor, controller, or other control logic. The processor 404 can be connected to a bus 402. However, any communication medium can be used to facilitate interaction with other components of controller 400 or to communicate externally with the system herein.

The controller 400 can also include a main memory 408. The main memory 408 can be random access memory (RAM) or other dynamic memory, might be used for storing information and instructions to be executed by processor. Main memory 408 might also be used for storing temporary variables or other intermediate information during execution of instructions to be executed by processor 404. The controller 400 might likewise include a read only memory (“ROM”) or other static storage device coupled to bus 402 for storing static information and instruction for processor 404.

The controller 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid-state drive, a magnetic tape drive, an optical drive, a compact disc (CD) or digital video disc (DVD) drive (R or RW), or other removable or fixed media drive might be provided. Storage media 414 might include, for example, a hard disk, an integrated circuit assembly, magnetic tape, cartridge, optical disk, a CD or DVD. Storage media 414 may be any other fixed or removable medium that is read by, written to or accessed by media drive 412.

As these examples illustrate, the storage media 414 can include a computer usable storage medium having stored therein computer software or data. In alternative examples, the information storage mechanism 410 might include other similar instrumentalities or allowing computer programs or other instructions or data to be loaded into the controller 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot. Other examples may include a PCMCIA slot and card, and other fixed or removable storage units 422 and interfaces 420 that allow software and data to be transferred from storage unit 422 to computing component 400.

The controller 400 can also include a communications interface 424. Communications interface 424 might be used to allow software and data to be transferred between the controller 400 and external devices. Examples of communications interface 424 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 424. These signals might be provided to communications interface 424 via a channel 428. Channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the controller 400 to perform features or functions of the present application as discussed herein. It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for training law enforcement personnel to anticipate a subject's action, the method comprising:
receiving information relating to the subject;
identifying, based on the received information, a pattern in at least one of the subject's: (i) behavior, (ii) movement, and (iii) interaction with a human; and
training law enforcement personnel using a specialized training module, the specialized training module including at least one of: (i) case studies comprising previous tactics used by the subjects to avoid capture by law enforcement personnel and successful capture techniques of subjects; (ii) pattern of life analysis of the subject; and (iii) surveillance of the subject.

2. The method of claim 1, wherein the subject is a fugitive.

3. The method of claim 1, wherein the specialized training module is tailored to the needs of a specific law enforcement agency.

4. The method of claim 3, wherein the law enforcement agency comprises at least one of: a federal agency; a state agency; and a local law enforcement agency.

5. The method of claim 4, wherein the law enforcement agency further comprises at least one of: (i) an international law enforcement agency; and (ii) a military branch.

6. The method of claim 1, wherein the surveillance of the subject includes static and mobile surveillance.

7. A non-transitory computer-readable medium having instructions stored thereon, that when executed by a processor, cause the processor to perform a method for training law enforcement personnel to anticipate a subject's action, the method comprising:
receiving, at the processor, information relating to the subject;
identifying, at the processor, a pattern in at least one of the subject's: (i) behavior, (ii) movement, and (iii) interaction with a human; and
displaying to law enforcement personnel, via a graphic user interface, a specialized training module, the specialized training module including at least one of: (i) case studies comprising previous tactics used by the subjects to avoid capture by law enforcement personnel and successful capture techniques of subjects; (ii) pattern of life analysis of the subject; and (iii) surveillance of the subject.

8. The non-transitory computer-readable medium of claim 7, wherein the method further includes identifying, at the processor, a pattern based on the received information.

9. The non-transitory computer-readable medium of claim 8, wherein the subject is a fugitive.

10. The non-transitory computer-readable medium of claim 8, wherein the specialized training module is tailored to the needs of a specific law enforcement agency.

11. The non-transitory computer-readable medium of claim 10, wherein the law enforcement agency comprises at least one of: a federal agency; a state agency; and a local law enforcement agency.

12. The non-transitory computer-readable medium of claim 11, wherein the law enforcement agency further comprises at least one of: (i) an international law enforcement agency; and (ii) a military branch.

13. The method of claim 8, wherein the surveillance of the subject includes static and mobile surveillance.

14. A system for training law enforcement personnel to anticipate a subject's action, the system comprising a processor configured to:
receive information relating to the subject;
identify, based on the received information, a pattern in at least one of the subject's:
(i) behavior, (ii) movement, and (iii) interaction with a human; and
display to law enforcement personnel, via a graphical user interface, a specialized training module, the specialized training module including at least one of: (i) case studies comprising previous tactics used by the subjects to avoid capture by law enforcement personnel and successful capture techniques of subjects; (ii) pattern of life analysis of the subject; and (iii) surveillance of the subject.

15. A method for training law enforcement personnel to anticipate a subject's action, the method comprising:
receiving information relating to the subject;
identifying, based on the received information, a pattern in at least one of the subject's: (i) behavior, (ii) movement, or (iii) interaction with a human; and
training law enforcement personnel using a specialized training module, the specialized training module including at least one of: (i) case studies comprising previous tactics used by the subjects to avoid capture by law enforcement personnel and successful capture techniques of subjects; (ii) pattern of life analysis of the subject; and (iii) surveillance of the subject.

16. The method of claim 15, wherein the subject is a fugitive.

17. The method of claim 15, wherein the specialized training module is tailored to the needs of a specific law enforcement agency.

18. The method of claim 17, wherein the law enforcement agency comprises at least one of: a federal agency; a state agency; and a local law enforcement agency.

19. The method of claim 18, wherein the law enforcement agency further comprises at least one of: (i) an international law enforcement agency; and (ii) a military branch.

20. The method of claim 15, wherein the surveillance of the subject includes static and mobile surveillance.
